(19) United States
(12) Patent Application Publication
(10) Pub. No.: US 2024/0430857 A1
(43) Pub. Date: Dec. 26, 2024

(54) PAGING EARLY INDICATION

(71) Applicant: LENOVO (BEIJING) LIMITED, Beijing (CN)

(72) Inventors: Yuantao ZHANG, Beijing (CN); Yingying LI, Beijing (CN); Hongmei LIU, Beijing (CN); Zhi YAN, Beijing (CN); Haiming WANG, Beijing (CN)

(21) Appl. No.: 18/294,908

(22) PCT Filed: Aug. 6, 2021
(86) PCT No.: PCT/CN2021/111234

§ 371 Date: Feb. 2, 2024

(51) Int. Cl. H04W 68/02; H04W 68/00

(52) U.S. Cl. CPC H04W 68/02; H04W 68/005

(57) ABSTRACT

Methods and apparatuses for paging early indication are disclosed. A method at an UE comprises receiving a paging configuration and a configuration for search space (SS) set for paging early indication (PEI); determining a target paging occasion (PO) for receiving paging message based on the paging configuration; determining a SS set duration for detecting a target PEI; and determining a bit sequence in the target PEI for the target PO based on at least an index of the SS set duration.

### FIELD

The subject matter disclosed herein generally relates to wireless communications, and more particularly relates to methods and apparatuses for paging early indication.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Downlink Control Channel (PDCCH), discontinuous reception (DRX), paging occasion (PO), paging frame (PF), Downlink control information (DCI), Synchronization Signal Block (SSB), Automatic Gain Control (AGC), signal to interference and noise ratio (SINR), paging early indication (PEI), search space (SS), control resource set (CORESET).

Paging allows the network (e.g. the gNB) to reach UEs in RRC_IDLE or RRC_INACTIVE state through paging messages, and to notify UEs of system information modification through short messages. Both paging messages and short messages are carried in a paging DCI transmitted in PDCCH.

The UE may use discontinuous reception (DRX) in RRC_IDLE or RRC_INACTIVE state in order to reduce power consumption. The UE monitors one paging occasion (PO) per DRX cycle (i.e., paging cycle). A PO is a set of PDCCH monitoring occasions and can consist of multiple time slots where the paging DCI is sent. One paging frame (PF) is one radio frame and may contain one or multiple POs. A UE can wake up from a sleep mode to receive the paging message and/or short message in a target PO (i.e. the PO for the UE). If the UE is not paged, the UE goes to sleep mode again.

The UE needs to decide a target PO in each paging cycle, and wakes up before the target PO and measure SSBs (Synchronization Signal Blocks) for AGC (Automatic Gain Control) and time and frequency tracking. Depending on channel status of UEs, different number of SSBs needs to be measured for different UEs. For example, the UEs with good channel status only need to measure 1 SSB, while the UEs with deteriorated channel status need to measure up to 3 SSBs. Therefore, the UE needs to measure the DL channel status, decides the number of SSBs to be measured, and wakes up before the target PO for measuring SSB(s). After that, the UE detects the target PO to check if there is paging message for the UE.

FIG. 1 (a) illustrates UE behavior on SSB measurement in each DRX cycle for UEs with low SINR (i.e. with deteriorated channel status), in which the UE measures three SSBs before the target PO. FIG. 1 (b) illustrates UE behavior on the SSB measurement in each DRX cycle for UEs with high SINR (i.e. with good channel status), in which the UE measures one SSB before the target PO. It can be seen from FIG. 1 (a) and FIG. 1 (b) that UE is in deep sleep mode (which needs the lowest power consumption) before measuring SSB, and then goes to light sleep mode upon measuring SSB(s) until PO detection. If there is no paging message for the UE in the PO detection, the UE goes back to deep sleep mode. The UE in RRC_IDLE or RRC_INACTIVE state can be in deep sleep mode or light sleep mode. The UE in the deep sleep mode needs to maintain much less hardware activation than in the light sloop mode. In the deep sleep mode, it is expected that the UE can achieve around 20 times power saving per time unit than in the light sleep mode.

The power consumption in the above-described paging process may still lead to high power consumption, considering low paging rate (e.g., 10%) in the actual network. This is because, even if the UE is not paged, the UE still needs to measure unnecessary SSB(s), go to the light sleep mode for a long period, and perform unnecessary PO detection (e.g., paging message reception), etc. In order to further reduce the power consumption in the paging process, a PEI (paging early indication) can be sent to the UE before the PO to indicate the UE whether it needs to perform PO detection (e.g., paging message reception).

FIGS. 2 (a) and 2 (b) illustrate PEI transmission for UEs with low SINR, where PEI is transmitted after the first SSB to be measured for the PO. In FIG. 2 (a), the PEI indicates the UE to detect the PO. Accordingly, the UE performs the same operations as those in FIG. 1 (a). In FIG. 2 (b), the PEI indicates the UE not to detect the PO. Therefore, the UE goes back to deep sleep mode after receiving the PEI.

The PEI might be carried in a DCI transmitted in PDCCH. The UE monitors PDCCH in a configured search space (SS) set. The SS set is configured to be associated with a control resource set (CORESET), which defines the time resource (e.g., number of OFDM symbols) and the frequency resource for PDCCH monitoring.

FIG. 3 illustrates PDCCH monitoring based on the SS set configuration. In each periodicity, the UE needs to monitor PDCCHs in each slot within a period defined by “duration”.

In the above description, one PEI for a UE is associated with one PO (one target PO for the UE). It means that one PEI indicates to the UE whether it needs to perform the paging detection in the one target PO. From system point of view, in order to have low PEI overhead, one PEI might be associated with N (N>=1) POs, which means that one PEI indicates whether there is paging message and/or short message in each of the N POs. From UE point of view, M (M>=1) PEIs might be associated with the target PO for a UE. The UE may determine, e.g. according to its channel quality, to detect one PEI among the M PEIs.

Accordingly, the following issues are needed to be addressed: From UE point of view, how to determine the number of PEIs associated with the target PO, so that UE could, e.g. based on channel quality, choose to detect one PEI among all PEI(s) associated with the target PO. In addition, how does the UE determine how many POs one PEI (e.g. the PEI chosen by the UE to detect, i.e. the target PEI) is associated with, and how does the UE determine the bits in the target PEI for the target PO.

This invention targets the above issues.

### BRIEF SUMMARY

Methods and apparatuses for paging early indication are disclosed.

In one embodiment, a method at an UE comprises receiving a paging configuration and a configuration for search space (SS) set for paging early indication (PEI); determining a target paging occasion (PO) for receiving paging message based on the paging configuration; determining a SS set duration for detecting a target PEI; and determining a bit sequence in the target PEI for the target PO based on at least an index of the SS set duration.

In one embodiment, the SS set for PEI is defined within a PEI detection window, which is configured in system information. The PEI detection window may have a fixed time domain size, and may end before the PF that contains the target PO. An SS set offset may be defined relative to the start of the PEI detection window; one SS set periodicity may be defined using SSB periodicity or a time slot as a unit, wherein a first SS set period starts from the end of the SS set offset; and in each SS set period, one SS set duration containing a set of consecutive slots is included. The number of consecutive slots in the SS set duration is equal to the number of beams for PEI transmission. In addition, SS set duration(s) are indexed in the PEI detection window.

In another embodiment, the method may further comprise determining the number of PEI(s) associated with the target PO based on the number of SS set duration(s) in the PEI detection window. In particular, the number of PEI(s) associated with the target PO is equal to the number of SS set duration(s) in the PEI detection window.

In still another embodiment, the method may further comprise determining a target PEI from the number of PEIs associated with the target PO based on UE channel quality. The index of the SS set duration for target PEI detection may be the same as an index of the target PEI. The method may further comprise determining the number of PFs or POs that are associated with the target PEI based on at least one of parameter A and parameter B: the parameter A is the number of SS set durations or the number of PEIs in the PEI detection window; and the parameter B is the maximum possible number of PFs within the length of the PEI detection window. The number of PFs with which one PEI is associated may be equal to the minimum value of parameter A and parameter B. The maximum possible number of PFs within the length of the PEI detection window may be equal to ceil (the length of the PEI detection window/PF periodicity).

In one embodiment, a method at a base unit comprises transmitting a paging configuration and a configuration for search space (SS) set for paging early indication (PEI); determining a paging occasion (PO) for transmitting paging message based on the paging configuration; determining a SS set duration for transmitting a PEI; and determining a bit sequence in the PEI for the PO based on at least an index of the SS set duration.

In another embodiment, a remote unit (UE) comprises a receiver that receives a paging configuration and a configuration for search space (SS) set for paging early indication (PEI); and a processor that determines a target paging occasion (PO) for receiving paging message based on the paging configuration, determines a SS set duration for detecting a target PEI, and determines a bit sequence in the target PEI for the target PO based on at least an index of the SS set duration.

In yet another embodiment, a base unit comprises a transmitter that a paging configuration and a configuration for search space (SS) set for paging early indication (PEI); and a processor that determines a paging occasion (PO) for transmitting paging message based on the paging configuration; determines a SS set duration for transmitting a PEI; and determines a bit sequence in the PEI for the PO based on at least an index of the SS set duration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 (a) illustrates UE behavior on SSB measurement in each DRX cycle for UEs with low SINR;

FIG. 1 (b) illustrates UE behavior on the SSB measurement in each DRX cycle for UEs with high SINR;

FIGS. 2 (a) and 2 (b) illustrate PEI transmission for UEs with low SINR, where PEI is transmitted after the first SSB to be measured for the PO;

FIG. 3 illustrates PDCCH monitoring based on the SS set configuration;

FIGS. 4 (a), 4 (b) and 4 (c) illustrate three exemplified configurations of SS set for PEI detection;

FIG. 5 (a) illustrates an example of determining the number of POs with which the target PEI is associated;

FIG. 5 (b) illustrates an example of determining the bit sequence in the target PEI for the target PO;

FIG. 6 (a) illustrates another example of determining the number of POs with which the target PEI is associated;

FIG. 6 (b) illustrates another example of determining the bit sequence in the target PEI for the target PO;

FIG. 7 (a) illustrates yet another example of determining the number of POs with which the target PEI is associated;

FIG. 7 (b) illustrates yet another example of determining the bit sequence in the target PEI for the target PO;

FIG. 8 is a schematic flow chart diagram illustrating an embodiment of a method;

FIG. 9 is a schematic flow chart diagram illustrating a further embodiment of a method; and

FIG. 10 is a schematic block diagram illustrating apparatuses according to one embodiment.

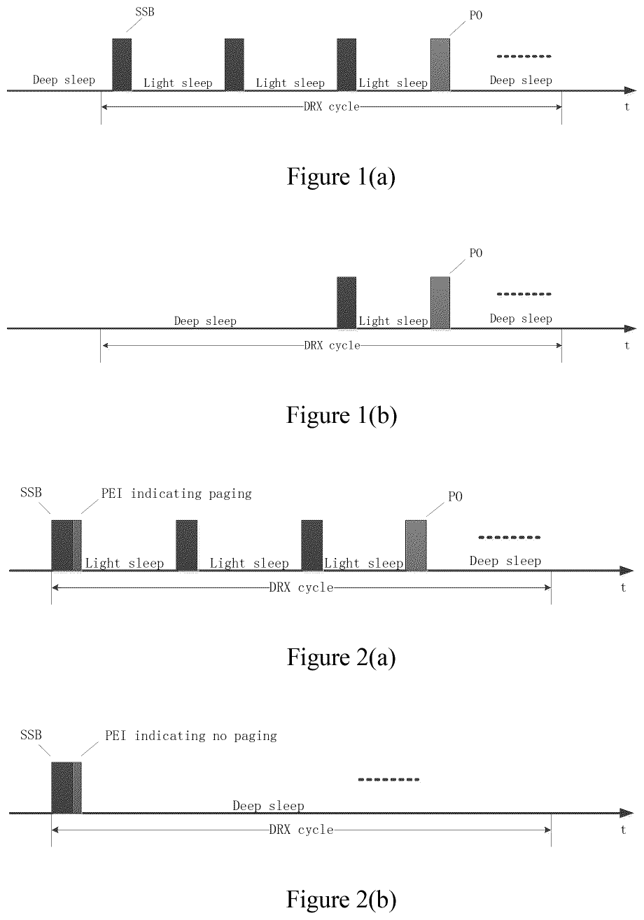

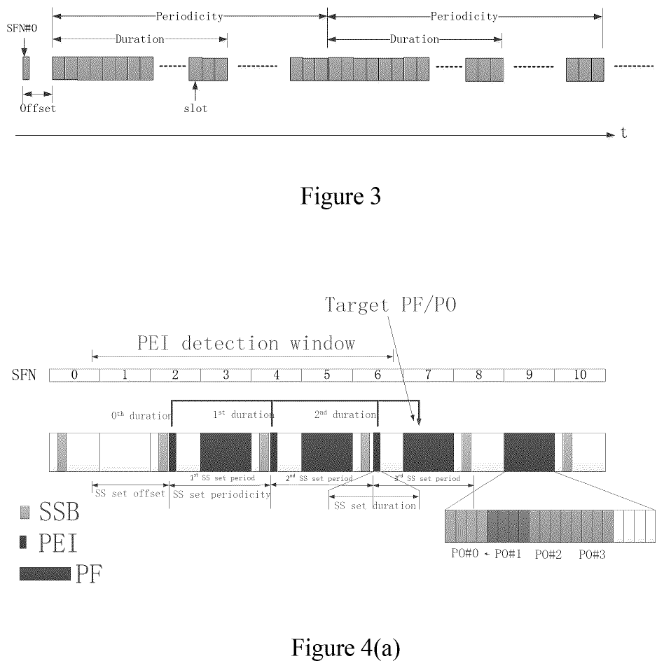

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

This application targets the issues described in the background part by proposing a configuration of search space (SS) set for PEI detection.

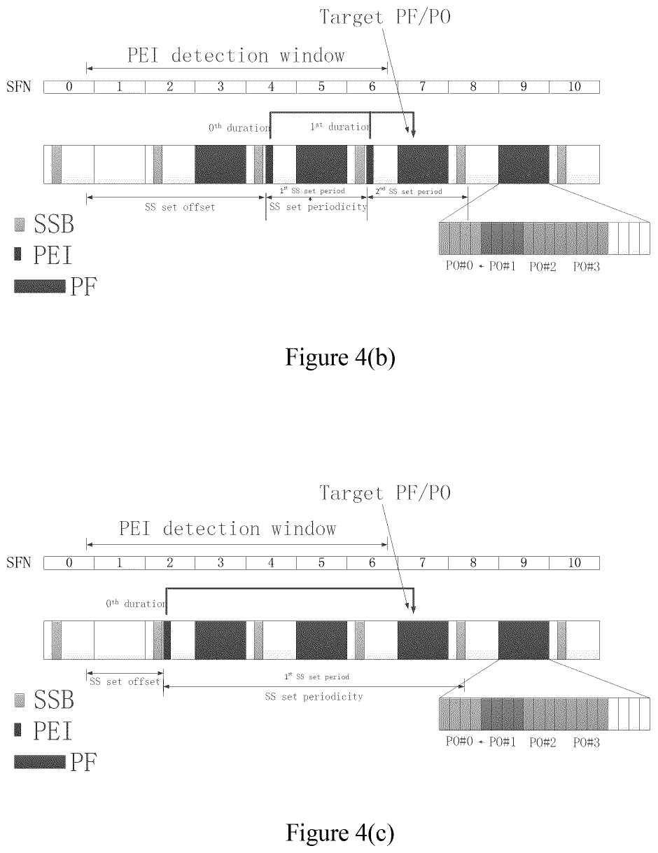

A first embodiment relates to determining the PEI(s) associated with the target PO. The first embodiment will be described with reference to FIGS. 4 (a), 4 (b) and 4 (c) that illustrate three exemplified configurations of SS set for PEI detection.

Four parameters are used to describe the configuration of SS set for PEI detection: PEI detection window size; SS set offset; SS set periodicity; and SS set duration.

The SS set for PEI detection is configured in the PEI detection window, which is configured in system information. For each UE, the PEI detection window ends before target PO or target PF containing the target PO for the UE. It is preferable that there is a time offset between the end of the PEI detection window and the target PO (or the target PF). For example, the time offset may be several time slots or several OFDM symbols. The PEI detection window has a predefined size (or length). Preferably, the length of the PEI detection window (maybe referred to as “PEI detection window size”) is a multiple of SSB periodicity. For example, if the SSB periodicity is 20 ms, the length of the PEI detection window can be 3 times of 20 ms, i.e., 60 ms, in each of FIGS. 4 (a), 4 (b) and 4 (c).

The SS set offset is defined relative to the start of the PEI detection window. The end of the SS set offset indicates the start of a first SS set duration, where each SS set duration is after the last SSB of a burst of SSBs (in each of FIGS. 4 (a), 4 (b) and 4 (c), “SSB” indicates a burst of SSBs). Preferably, there is a small time offset between the end of the SSB and start of the SS set duration. For example, the small time offset may be several time slots or several OFDM symbols. In FIG. 4 (a), the SS set offset is 18 ms; in FIG. 4 (b), the SS set offset is 38 ms; and in FIG. 4 (c), the SS set offset is 18 ms.

The SS set periodicity is the periodicity between two adjacent SS set durations within the PEI detection window. If the SS set offset plus the SS set periodicity is larger than the length of the PEI detection window, there is only one SS set duration. Within each SS set periodicity (maybe referred to as “SS set period”), there is one SS set duration. The length of the SS set periodicity can be defined by taking the SSB periodicity (i.e., 20 ms) or a time slot as unit. For example, the length of the SS set periodicity can be 20 ms, 40 ms or 60 ms. In FIG. 4 (a), the length of the SS set periodicity is 20 ms (which means that each of three SS set periods (1^{st} SS set period, 2^{nd} SS set period and 3^{rd} SS set period shown in FIG. 4 (a)) is 20 ms); in FIG. 4 (b), the length of the SS set periodicity is 20 ms (which means that each of two SS set periods (1^{st} SS set period and 2^{nd} SS set period shown in FIG. 4 (b)) is 20 ms); in FIG. 4 (c), the length of the SS set periodicity is 60 ms (which means that the only one SS set period (1^{st} SS set period in FIG. 4 (c)) is 60 ms). Note that the first SS set period (1^{st} SS set period in each of FIGS. 4 (a), 4 (b) and 4 (c)) starts from the end of the SS set offset; and the last SS set period (3^{rd} SS set period shown in FIG. 4 (a), 2^{nd} SS set period shown in FIG. 4 (b), and 1^{st} SS set period in FIG. 4 (c)) may extend beyond the PEI detection window.

Each SS set duration contains a set of consecutive slots, the number of which is by default the same as the number of transmitted beams used by the gNB. The number of transmitted beams is the same as the number of actually transmitted SSBs or a subset of SSBs, each of which is transmitted by a specific beam. The DCI for PEI is transmitted per beam and starts from a first slot of the SS set duration. In each of FIGS. 4 (a), 4 (b) and 4 (c), the SS set duration is 1 ms (which is equal to two slots).

For a given PEI detection window, different configurations of the SS set offset and the SS set periodicity can lead to different number of PEIs associated with one PO (e.g. target PO). The number of PEIs with which the target PO is associated is determined based on the number of SS set durations in the PEI detection window. Considering that one PEI is included in one SS set duration, the number of PEIs with which one target PO is associated is equal to the number of SS set durations in the PEI detection window. In the example of FIG. 4 (a), the number of SS set durations in the PEI detection window is 3, and accordingly the number of PEIs with which the target PO is associated is equal to 3. In the example of FIG. 4 (b), the number of SS set durations in the PEI detection window is 2, and accordingly the number of PEIs with which the target PO is associated is equal to 2. In the example of FIG. 4 (c), the number of SS set durations in the PEI detection window is 1, and accordingly the number of PEIs with which the target PO is associated is equal to 1.

When the number of PEIs with which the target PO is associated (i.e. the number of SS set durations in the PEI detection window) is determined, the UE can determine one SS set duration in the PEI detection window to detect PEI. The determination can be made based on the channel quality measured by the UE.

Table 1 provides the values for the PEI detection window size; the SS set offset; the SS set periodicity; and the SS set duration in each of FIGS. 4 (a), 4 (b) and 4 (c).

TABLE 1

| | | | |
|---|---|---|---|
| Parameters | FIG. 4(a) | FIG. 4(b) | FIG. 4(c) |

| | | | | | | |
|---|---|---|---|---|---|---|
| PEI detection window | 60 | ms | 60 | ms | 60 | ms |
| size | | | | | | |
| SS set offset | 18 | ms | 38 | ms | 18 | ms |
| SS set periodicity | 20 | ms | 20 | ms | 60 | ms |
| SS set duration | 1 | ms | 1 | ms | 1 | ms |

Based on different configurations of SS set for PEI detection shown in each of FIGS. 4 (a), 4 (b) and 4 (c), FIG. 4 (a) achieves three SS sets for one PO, which means three PEIs for 1 PO; FIG. 4 (b) achieves two SS sets for one PO, which means two PEIs for one PO; and FIG. 4 (c) achieves one SS set for one PO, which means one PEI for one PO. The UE chooses, e.g. based on its measured channel quality, one SS set duration to detect the PEI (maybe referred to as “target PEI”) for the one PO (i.e. the target PO).

A second embodiment relates to determining the number of POs with which a PEI (e.g. target PEI) is associated, and the bit sequence in the PEI (e.g. target PEI) for the target PO.

The number of PFs with which a PEI is associated is determined according to at least one of parameter A (the number of SS set durations (i.e., number of PEIs) in the PEI detection window) and parameter B (the maximum possible number of PFs within the length of the PEI detection window, which is equal to ceil (the length of the PEI detection window/PF periodicity), where ceil(x) means the smallest integer that is equal to or larger than x). In particular, the number of PFs with which a PEI is associated is equal to the minimum value of the parameter A and the parameter B. Incidentally, the PF periodicity is the time duration between two consecutive PFs in a DRX cycle and is determined from a paging configuration.

The number of POs within a PF is configured in the paging configuration. Based on the determined number of PFs with which a PEI is associated (denoted as P) and the number of POs within a PF (denoted as Q), the number of POs with which a PEI is associated (denoted as N) is N=P*Q.

The bit sequence in the PEI for the target PO is determined at least according to the index of SS set duration for the PEI in the PEI detection window. In particular, the bit sequence in the PEI for the target PO is determined according to at least one of the index of SS set duration for the PEI in the PEI detection window, the number of SS set durations (i.e., the number of PEIs) in the PEI detection window, and the maximum possible number of PFs within the length of the PEI detection window.

The SS set duration in the PEI detection window is indexed, e.g., starting from index 0. For example, in FIG. 4 (a), three SS set durations are the 0^{th} duration, the 1^{st} duration and the 2^{nd} duration; in FIG. 4 (b), two SS set durations are the 0^{th} duration and the 1^{st} duration; and in FIG. 4 (c), one SS set duration is the 0^{th} duration.

The UEs that receive paging message in a same PO can be further divided into subgroups (or UE subgroups). The PEI can indicate if there is paging message for each of UE subgroups. The number of UE subgroups in a PO is also configured in the paging configuration.

The number of bits carried in a PEI is determined according to the number of POs with which the PEI is associated (i.e., N), the number of UE subgroups in each PO (denoted as G) and the number of bits for other purpose e.g. for short message (denoted as Y). In particular, the number of bits carried in the PEI (denoted as T) is T=N*G+Y.

With N POs associated with one PEI, and there are M SS set duration(s) in the PEI detection window, the UE chooses to detect the m^{th} (m is from 0 to M−1) SS set duration for the PEI, then the bit sequence for the target PF is determined as floor (m/ceil(A/B))*Q*G˜(floor(m/ceil(A/B))+1)*Q*G−1, where A, B are the above-described parameter A (the number of SS set durations (i.e., number of PEIs) in the PEI detection window) and B (the maximum possible number of PFs within the length of the PEI detection window); Q is the number of POs within a PF; G is the number of UE subgroups in each PO. Ceil(x) means the smallest integer that is equal to or larger than x. Floor(x) means the largest integer that is equal to or smaller than x.

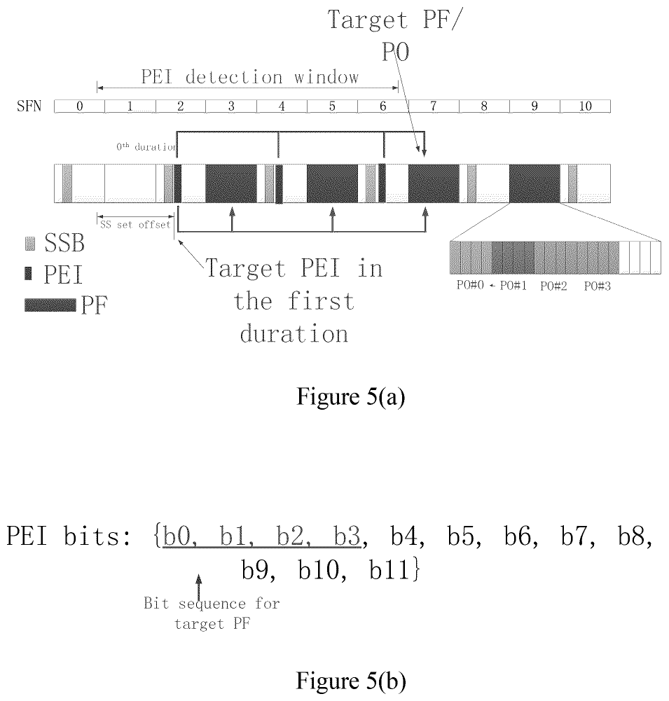

FIG. 5 (a) illustrates an example of determining the number of POs with which the target PEI is associated, and FIG. 5 (b) illustrates an example of determining the bit sequence in the target PEI for the target PO. The configuration of SS set for the PEI detection in FIG. 5 (a) is the same as FIG. 4 (a). The PF periodicity in the example of FIG. 5 (a) is 20 ms.

In the example of FIG. 5 (a), the parameter A (i.e. the number of SS set durations (i.e., the number of PEIs) in the PEI detection window) is 3; and the parameter B (the maximum possible number of PFs within the length of the PEI detection window) is equal to ceil (60/20)=3. Therefore, one PEI is associated with 3 PFs (the minimum value of 3 and 3).

In the example of FIG. 5 (a), the number of POs within a PF is 4. Accordingly, the number of POs with which the target PEI is associated is N=P*Q=3*4=12.

In the example of FIG. 5 (a), the number of UE subgroups in a PO (G) is 1. In addition, suppose that the number of bits for other purpose (Y) is 0. Accordingly, the number of bits carried in the PEI is T=N*G+Y=12*1+0=12 bits.

In FIG. 5 (a), the UE detects the 0^{th} SS set duration for PEI (target PEI) detection. Accordingly, the bit sequence in the target PEI for the target PF is decided by the index of the first SS set duration (i.e. 0). In particular, the bit sequence in the target PEI for the target PF is floor(0/ceil(3/3))*4*1˜(floor(0/ceil(3/3))+1)*4*1−1, i.e., bits 0˜3 in the PEI, shown as b0, b1, b2 and b3 in FIG. 5 (b). Since the number of UE subgroups in a PO (G) is 1, the bit for the target PO is then determined by the index of the PO in the target PF, i.e., each bit corresponds to one PO in the PF. In this example, suppose that the target PO is the second PO in the target PF, the bit in the PEI that associated with this PO (the second PO) is the second bit in the bit sequence for the target PF, i.e., b1.

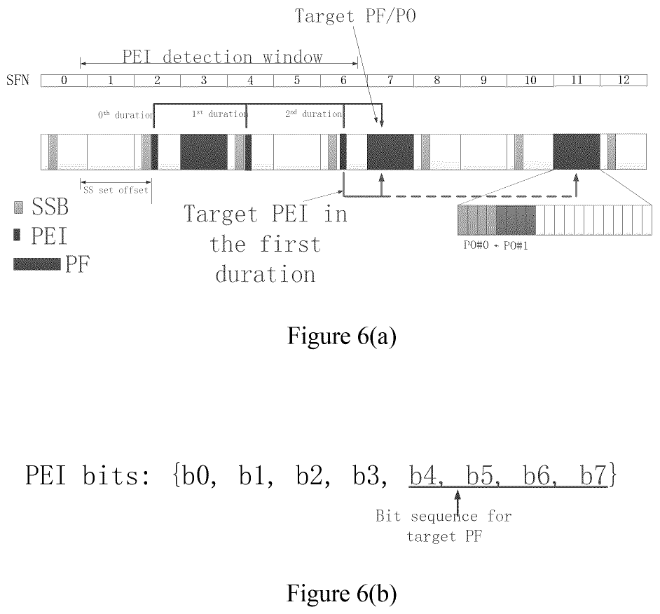

FIG. 6 (a) illustrates another example of determining the number of POs with which the target PEI is associated, and FIG. 6 (b) illustrates another example of determining the bit sequence in the target PEI for the target PO. The configuration of SS set for the PEI detection in FIG. 6 (a) is the same as FIG. 4 (a). The PF periodicity in the example of FIG. 6 (a) is 40 ms.

In the example of FIG. 6 (a), the parameter A (i.e. the number of SS set durations (i.e., number of PEIs) in the PEI detection window) is 3; and the parameter B (the maximum possible number of PFs within the length of the PEI detection window) is equal to ceil (60/40)=2. Therefore, one PEI is associated with 2 PFs (the minimum value of 3 and 2).

In the example of FIG. 6 (a), the number of POs within a PF is 2. Accordingly, the number of POs with which the target PEI is associated is N=P*Q=2*2=4.

In the example of FIG. 6 (a), the number of UE subgroups in a PO is 2. In addition, suppose that the number of bits for other purpose (Y) is 0. Accordingly, the number of bits carried in the PEI (T) is T=N*G+Y=4*2+0=8 bits.

In FIG. 6 (a), the UE detects the 2^{nd} SS set duration for PEI (target PEI) detection. Accordingly, the bit sequence in the target PEI for the target PF is decided by the index of the SS set duration (i.e. 2). In particular, the bit sequence in the target PEI for the target PF is floor(2/ceil(3/2))*2*2˜(floor(2/ceil(3/2))+1)*2*2−1, i.e., bits 4˜7 in the PEI, shown as b4, b5, b6 and b7 in FIG. 6 (b). Since the number of UE subgroups in a PO (G) is 2, two bits correspond to one PO in the PF. The two bits for the target PO is then determined by the index of the PO in the target PF, i.e., the first two bits (b4 and b5) are for the two UE subgroups of the first PO, and the last two bits (b6 and b7) are for the two UE subgroups of the second PO.

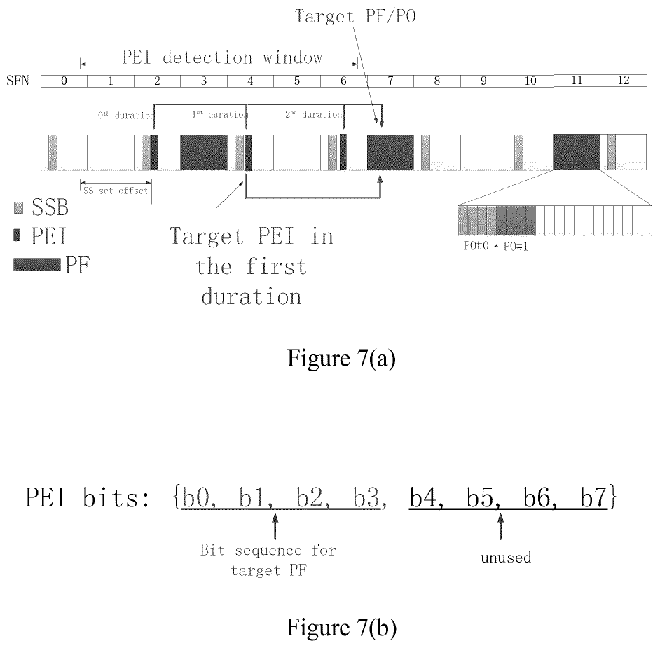

FIG. 7 (a) illustrates yet another example of determining the number of POs with which the target PEI is associated, and FIG. 7 (b) illustrates yet another example of determining the bit sequence in the target PEI for the target PO. The configuration of SS set for the PEI detection in FIG. 7 (a) is the same as FIG. 4 (a). The PF periodicity in the example of FIG. 7 (a) is 40 ms.

In the example of FIG. 7 (a), the parameter A and the parameter B are same with those in the example of FIG. 6 (a), i.e., the parameter A (i.e. the number of SS set durations (i.e., number of PEIs) in the PEI detection window) is 3; and the parameter B (the maximum possible number of PFs within the length of the PEI detection window) is equal to ceil (60/40)=2. Therefore, one PEI is associated with 2 PFs (the minimum value of 3 and 2).

In the example of FIG. 7 (a), the number of POs within a PF is the same as that in the example of FIG. 6 (a), i.e., is equal to 2. Accordingly, the number of POs with which the target PEI is associated is N=P*Q=2*2=4.

In the example of FIG. 7 (a), the number of UE subgroups in a PO is 2. In addition, suppose that the number of bits for other purpose (Y) is 0. Accordingly, the number of bits carried in the PEI (T) is T=N*G+Y=4*2+0=8 bits.

In FIG. 7 (a), the UE detects the 1^{st} SS set duration for PEI (target PEI) detection. Accordingly, the bit sequence in the target PEI for the target PF is decided by the index of the SS set duration (i.e. 1). In particular, the bit sequence in the target PEI for the target PF is floor(1/ceil(3/2))*2*2˜(floor(1/ceil(3/2))+1)*2*2−1, i.e., bits 0˜3 in the PEI, shown as b0, b1, b2 and b3 in FIG. 7 (b). Since the number of UE subgroups in a PO (G) is 2, two bits correspond to one PO in the PF. The two bits for the target PO is then determined by the index of the PO in the target PF, i.e., the first two bits (b0 and b1) are for the two UE subgroups of the first PO, and the last two bits (b2 and b3) are for the two UE subgroups of the second PO. Besides, since the PEI in the 1^{st} duration indicates the existence of paging messages for the POs of only 1 PF, the remaining 4 bits in the PEI in the 1^{st} duration are unused. FIG. 7 (b) illustrates the unused bits: b4, b5, b6 and b7.

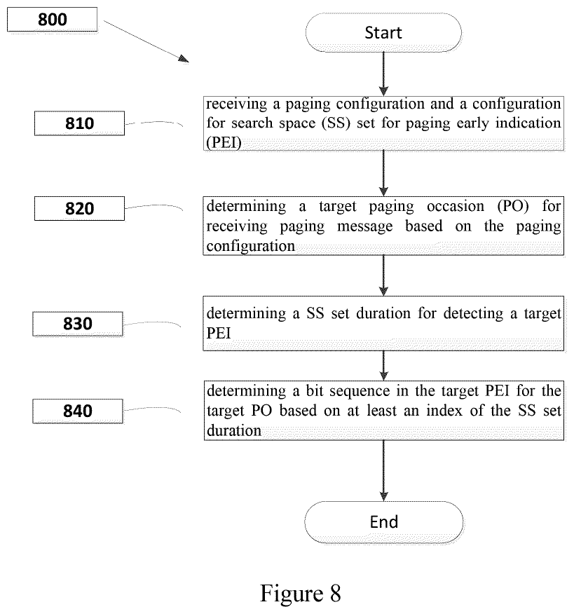

FIG. 8 is a schematic flow chart diagram illustrating an embodiment of a method 800 according to the present application. In some embodiments, the method 800 is performed by an apparatus, such as a remote unit (UE). In certain embodiments, the method 800 may be performed by a processor executing program code, for example, a microcontroller, a microprocessor, a CPU, a GPU, an auxiliary processing unit, a FPGA, or the like.

The method 800 may include 810 receiving a paging configuration and a configuration for search space (SS) set for paging early indication (PEI); 820 determining a target paging occasion (PO) for receiving paging message based on the paging configuration; 830 determining a SS set duration for detecting a target PEI; and 840 determining a bit sequence in the target PEI for the target PO based on at least an index of the SS set duration.

In one embodiment, the SS set for PEI is defined within a PEI detection window, which is configured in system information. The PEI detection window may have a fixed time domain size, and may end before the PF that contains the target PO. An SS set offset may be defined relative to the start of the PEI detection window; one SS set periodicity may be defined using SSB periodicity or a time slot as a unit, wherein a first SS set period starts from the end of the SS set offset; and in each SS set period, one SS set duration containing a set of consecutive slots is included. The number of consecutive slots in the SS set duration is equal to the number of beams for PEI transmission. In addition, SS set duration(s) are indexed in the PEI detection window.

In some embodiment, the method may further comprise determining the number of PEI(s) associated with the target PO based on the number of SS set duration(s) in the PEI detection window. In particular, the number of PEI(s) associated with the target PO is equal to the number of SS set duration(s) in the PEI detection window.

In some embodiment, the method may further comprise determining a target PEI from the number of PEIs associated with the target PO based on UE channel quality. The index of the SS set duration for target PEI detection may be the same as an index of the target PEI. The method may further comprise determining the number of PFs or POs that are associated with the target PEI based on at least one of parameter A and parameter B: the parameter A is the number of SS set durations or the number of PEIs in the PEI detection window; and the parameter B is the maximum possible number of PFs within the length of the PEI detection window. The number of PFs with which one PEI is associated may be equal to the minimum value of parameter A and parameter B. The maximum possible number of PFs within the length of the PEI detection window may be equal to ceil (the length of the PEI detection window/PF periodicity).

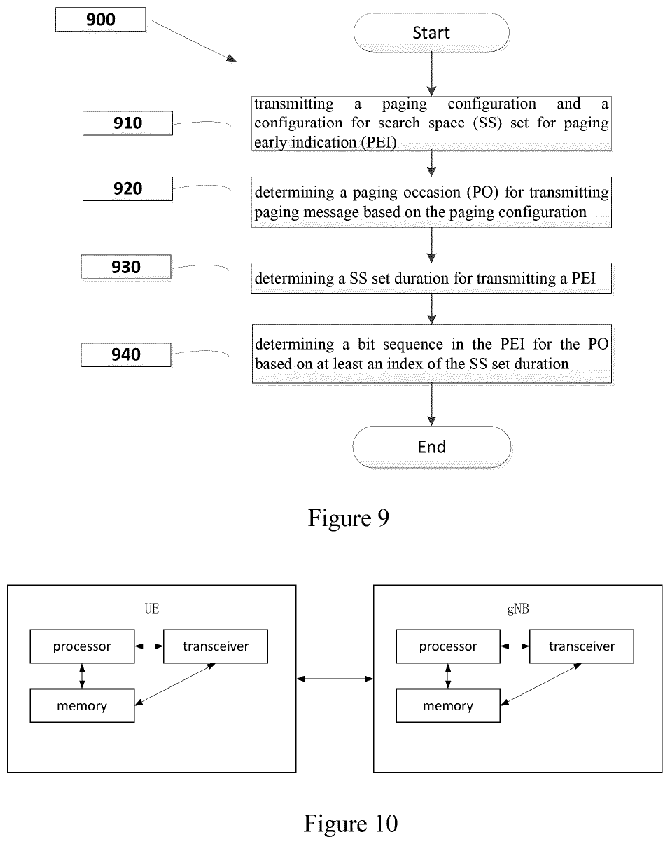

FIG. 9 is a schematic flow chart diagram illustrating a further embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may include 910 transmitting a paging configuration and a configuration for search space (SS) set for paging early indication (PEI); 920 determining a paging occasion (PO) for transmitting paging message based on the paging configuration; 930 determining a SS set duration for transmitting a PEI; and 940 determining a bit sequence in the PEI for the PO based on at least an index of the SS set duration.

In one embodiment, the SS set for PEI is defined within a PEI detection window, which is configured in system information. The PEI detection window may have a fixed time domain size, and may end before the PF that contains the PO. An SS set offset may be defined relative to the start of the PEI detection window; one SS set periodicity may be defined using SSB periodicity or a time slot as a unit, wherein a first SS set period starts from the end of the SS set offset; and in each SS set period, one SS set duration containing a set of consecutive slots is included. The number of consecutive slots in the SS set duration is equal to the number of beams for PEI transmission. In addition, SS set duration(s) are indexed in the PEI detection window.

In some embodiment, the method may further comprise determining the number of PEI(s) associated with the PO based on the number of SS set duration(s) in the PEI detection window. In particular, the number of PEI(s) associated with the PO is equal to the number of SS set duration(s) in the PEI detection window.

In some embodiment, the method may further comprise determining a PEI from the number of PEIs associated with the PO. The index of the SS set duration for PEI detection may be the same as an index of the PEI. The method may further comprise determining the number of PFs or POs that are associated with the PEI based on at least one of parameter A and parameter B: the parameter A is the number of SS set durations or the number of PEIs in the PEI detection window; and the parameter B is the maximum possible number of PFs within the length of the PEI detection window. The number of PFs with which one PEI is associated may be equal to the minimum value of parameter A and parameter B. The maximum possible number of PFs within the length of the PEI detection window may be equal to ceil (the length of the PEI detection window/PF periodicity).

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 8.

The UE comprises a receiver that receives a paging configuration and a configuration for search space (SS) set for paging early indication (PEI); and a processor that determines a target paging occasion (PO) for receiving paging message based on the paging configuration, determines a SS set duration for detecting a target PEI, and determines a bit sequence in the target PEI for the target PO based on at least an index of the SS set duration.

In one embodiment, the SS set for PEI is defined within a PEI detection window, which is configured in system information. The PEI detection window may have a fixed time domain size, and may end before the PF that contains the target PO. An SS set offset may be defined relative to the start of the PEI detection window; one SS set periodicity may be defined using SSB periodicity or a time slot as a unit, wherein a first SS set period starts from the end of the SS set offset; and in each SS set period, one SS set duration containing a set of consecutive slots is included. The number of consecutive slots in the SS set duration is equal to the number of beams for PEI transmission. In addition, SS set duration(s) are indexed in the PEI detection window.

In some embodiment, the processor may further determine the number of PEI(s) associated with the target PO based on the number of SS set duration(s) in the PEI detection window. In particular, the number of PEI(s) associated with the target PO is equal to the number of SS set duration(s) in the PEI detection window.

In some embodiment, the processor may further determine a target PEI from the number of PEIs associated with the target PO based on UE channel quality. The index of the SS set duration for target PEI detection may be the same as an index of the target PEI. The processor may further determine the number of PFs or POs that are associated with the target PEI based on at least one of parameter A and parameter B: the parameter A is the number of SS set durations or the number of PEIs in the PEI detection window; and the parameter B is the maximum possible number of PFs within the length of the PEI detection window. The number of PFs with which one PEI is associated may be equal to the minimum value of parameter A and parameter B.

The maximum possible number of PFs within the length of the PEI detection window may be equal to ceil (the length of the PEI detection window/PF periodicity).

Referring to FIG. 10, the gNB (i.e. base unit) includes a processor, a memory, and a transceiver. The processors implement a function, a process, and/or a method which are proposed in FIG. 9.

The base unit comprises a transmitter that a paging configuration and a configuration for search space (SS) set for paging early indication (PEI); and a processor that determines a paging occasion (PO) for transmitting paging message based on the paging configuration; determines a SS set duration for transmitting a PEI; and determines a bit sequence in the PEI for the PO based on at least an index of the SS set duration.

In one embodiment, the SS set for PEI is defined within a PEI detection window, which is configured in system information. The PEI detection window may have a fixed time domain size, and may end before the PF that contains the PO. An SS set offset may be defined relative to the start of the PEI detection window; one set period may be defined using SSB periodicity or a time slot as a unit, wherein a first SS set period starts from the end of the SS set offset; and in each SS set period, one SS set duration containing a set of consecutive slots is included. The number of consecutive slots in the SS set duration is equal to the number of beams for PEI transmission. In addition, SS set duration(s) are indexed in the PEI detection window.

In some embodiment, the processor may further determine the number of PEI(s) associated with the PO based on the number of SS set duration(s) in the PEI detection window. In particular, the number of PEI(s) associated with the PO is equal to the number of SS set duration(s) in the PEI detection window.

In some embodiment, the processor may further determine a PEI from the number of PEIs associated with the PO. The index of the SS set duration for PEI detection may be the same as an index of the PEI. The processor may further determine the number of PFs or POs that are associated with the PEI based on at least one of parameter A and parameter B: the parameter A is the number of SS set durations or the number of PEIs in the PEI detection window; and the parameter B is the maximum possible number of PFs within the length of the PEI detection window. The number of PFs with which one PEI is associated may be equal to the minimum value of parameter A and parameter B. The maximum possible number of PFs within the length of the PEI detection window may be equal to ceil (the length of the PEI detection window/PF periodicity).

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a paging configuration and a configuration for search space (SS) set for paging early indication (PEI);
determine a target paging occasion (PO) for receiving paging message based on the paging configuration;
determine a SS set duration for detecting a target PEI;
determine a bit sequence in the target PEI for the target PO based on at least an index of the SS set duration.

2. The UE of claim 1, wherein, the SS set for PEI is defined within a PEI detection window, which is configured in system information.

3. The UE of claim 2, wherein, the PEI detection window has a fixed time domain size, and ends before a paging frame (PF) that contains the target PO.

4. The UE of claim 2, wherein,
an SS set offset is defined relative to the start of the PEI detection window;
one SS set periodicity is defined using SSB periodicity as a unit, wherein a first SS set period starts from an end of the SS set offset; and
in each SS set period, one SS set duration containing a set of consecutive slots is included.

5. The UE of claim 4, wherein, a number of consecutive slots in the SS set duration is equal to a number of beams for PEI transmission.

6. The UE of claim 2, wherein, SS set duration(s) are indexed in the PEI detection window.

7. The UE of claim 1, wherein the processor is further configured to cause the UE to:
determine a number of PEI(s) associated with the target PO based on a number of SS set duration(s) in a PEI detection window.

8. The UE of claim 7, wherein, the number of PEI(s) associated with the target PO is equal to the number of SS set duration(s) in the PEI detection window.

9. The UE of claim 7, further comprising:
determining a target PEI from the number of PEIs associated with the target PO based on UE channel quality.

10. The UE of claim 9, wherein the index of the SS set duration for target PEI detection is the same as an index of the target PEI.

11. The UE of claim 9, wherein the processor is further configured to cause the UE to:
determine a number of paging frames (PFs) or POs that are associated with the target PEI based on at least one of parameter A and parameter B:
wherein the parameter A is the number of SS set durations or the number of PEIs in the PEI detection window; and
wherein the parameter B is a maximum possible number of PFs within a length of the PEI detection window.

12. The UE of claim 11, wherein, the number of PFs with which one PEI is associated is equal to a minimum value of parameter A and parameter B.

13. The UE of claim 11, wherein, the maximum possible number of PFs within the length of the PEI detection window is equal to ceil (the length of the PEI detection window/PF periodicity).

14. (canceled)

15. A base unit, comprising:
at least one memory; and
at least one processor coupled with the at least one memory and configured to cause the base unit to:
transmit a paging configuration and a configuration for search space (SS) set for paging early indication (PEI);
determine a paging occasion (PO) for transmitting paging message based on the paging configuration;
determine a SS set duration for transmitting a PEI; and
determine a bit sequence in the PEI for the PO based on at least an index of the SS set duration.

16. A processor for wireless communication, comprising:
at least one controller coupled with at least one memory and configured to cause the processor to:
receive a paging configuration and a configuration for search space (SS) set for paging early indication (PEI);
determine a target paging occasion (PO) for receiving paging message based on the paging configuration;
determine a SS set duration for detecting a target PEI;
determine a bit sequence in the target PEI for the target PO based on at least an index of the SS set duration.

17. The processor of claim 16, wherein, the SS set for PEI is defined within a PEI detection window, which is configured in system information.

18. The processor of claim 17, wherein, the PEI detection window has a fixed time domain size, and ends before a paging frame (PF) that contains the target PO.

19. A method performed by a user equipment (UE), the method comprising:
receiving a paging configuration and a configuration for search space (SS) set for paging early indication (PEI);
determining a target paging occasion (PO) for receiving paging message based on the paging configuration;
determining a SS set duration for detecting a target PEI;
determining a bit sequence in the target PEI for the target PO based on at least an index of the SS set duration.

20. The method of claim 19, wherein, the SS set for PEI is defined within a PEI detection window, which is configured in system information.

21. The method of claim 20, wherein, the PEI detection window has a fixed time domain size, and ends before a paging frame (PF) that contains the target PO.
